(19) United States
(12) Patent Application Publication
(10) Pub. No.: US 2008/0123207 A1
(43) Pub. Date: May 29, 2008

(54) Back-hair-trim-guide with an adjustable mirror for man

(76) Inventor: Daniel Li, Germantown, MD (US)

Correspondence Address: Daniel Li, 14024 Bromfield Rd., Germantown, MD, 20874, US

(21) Appl. No.: 11/451,466

(22) Filed: Nov. 27, 2006

(51) Int. Cl. G02B 7/182

(52) U.S. Cl. 359/879; 359/871

(57) ABSTRACT

The claimed utility is called back-hair-trim-guide with an adjustable mirror for man. It trims man's back and side hair safely and effectively with a clipper. It comprises the following five parts,
1. An utility holding bar to hold the back mirror and back hair guides
2. An adjustable back hair mirror,
3. Two adjustable back hair protection cover (guides)
4. A front belt with both ends connecting to either ends of the said utility holding bar. Its length is adjustable.
5. A top belt with both ends connecting to either ends of the said utility holding bar. Its length is adjustable.

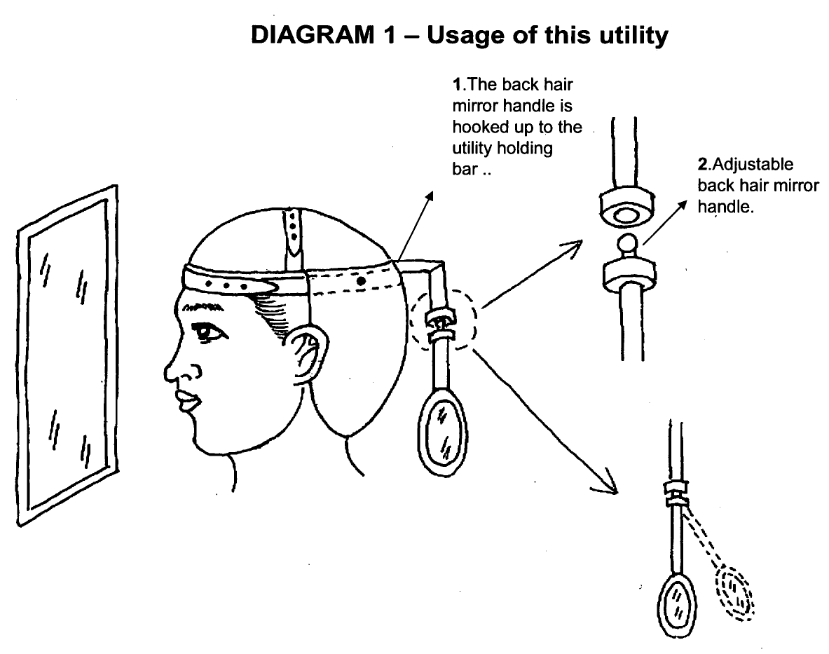

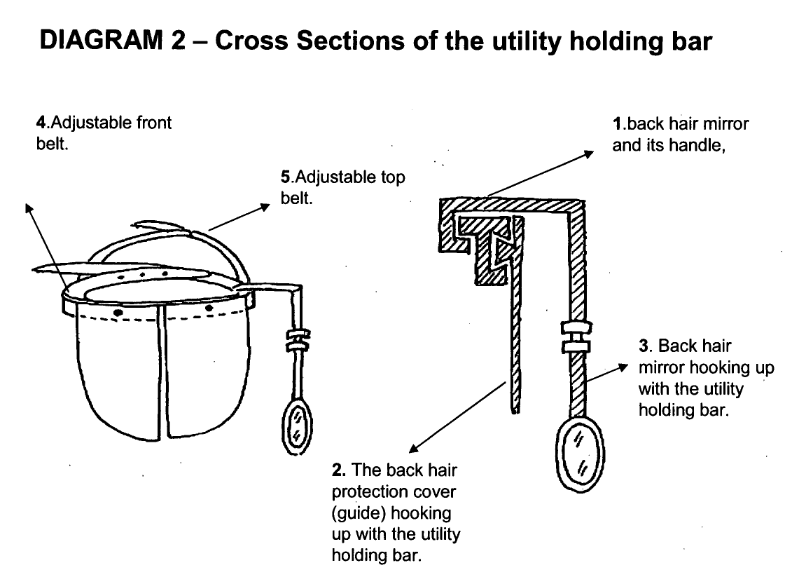

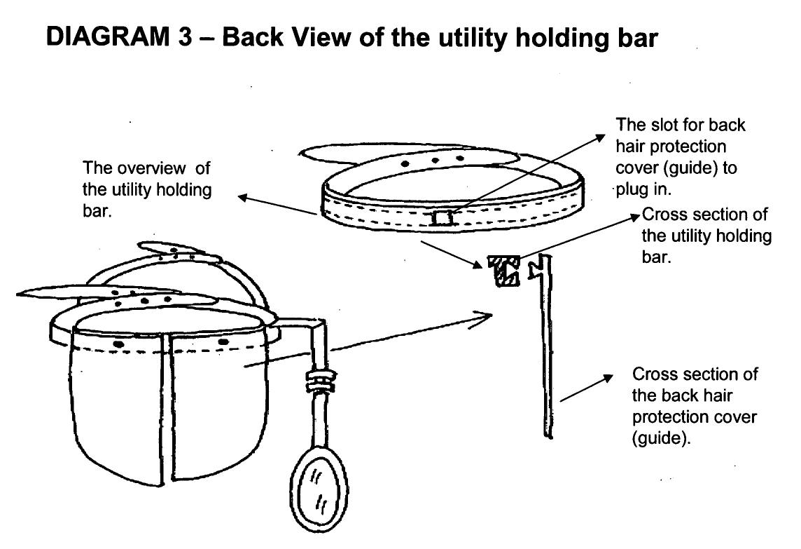

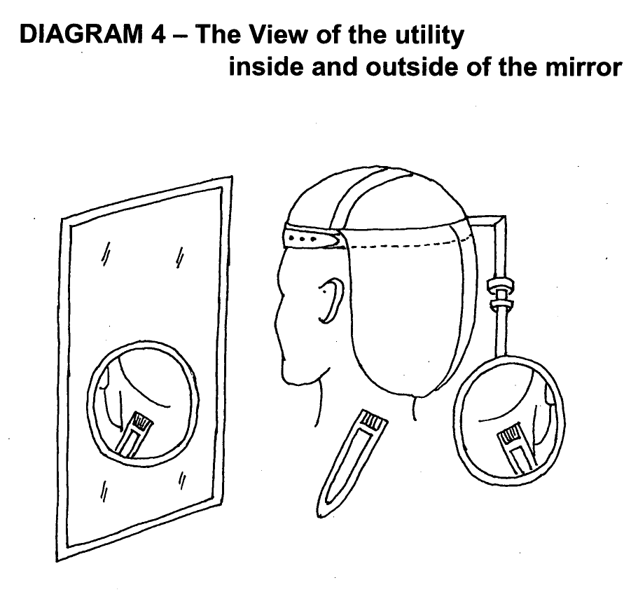

### THE UTILITY HOLDING BAR

This utility holding bar is for engaging the head of the person whose back and side hair is to be trimmed. Please see Diagram 3, the overview of the utility holding bar, and Diagram 2, the cross section of the utility holding bar. This utility holding bar performs two functions:

A. The first layer or the inner layer of this bar will hold the back hair mirror which is going to slide along the utility holding bar from left to right or vise versa as needed so that the person can have a better vision of his back and side hair to be trimmed by looking at the front mirror into this attached back hair mirror.

B. The second layer of this utility holding bar will hold two movable back hair protection cover (guides) to protect and cover the back and side hair, and only expose the unwanted hair to be trimmed.

### AN ADJUSTABLE BACK HAIR MIRROR

### (Please See Diagram 1—the Usage of this Utility.)

This mirror is attached to the first layer or the inner layer of the said utility holding bar through its handle, and it can move along the said utility holding bar to adjust its position and its angle so that the person can see his back and side hair by looking at the front mirror into this mirror when trimming the unwanted hair. This mirror has a handle which it self is flexible and adjustable to reflect the back and side hair position.

### TWO ADJUSTABLE BACK HAIR PROTECTION COVERS (GUIDES)

### (Please see Diagram 2, and Diagram 3).

There are two identical back hair protection covers (guides) both having the shape of back and side hair. They are attached to the second layer of the said utility holding bar, and movable along the said utility holding bar so that a person can adjust the covered hair easily and freely.

### A FRONT BELT WITH BOTH ENDS CONNECTING TO EITHER ENDS OF THE SAID UTILITY HOLDING BAR

The function of this front belt is to connect both ends of the said utility holding bar and to adjust the length of the belt according to individuals using this utility. Please see Diagram 1, and Diagram 2.

### A TOP BELT WITH BOTH ENDS CONNECTING TO EITHER ENDS OF THE SAID UTILITY HOLDING BAR

The function of this top belt is to connect to the both ends of the said bar, and to adjust the height of the back hair protection covers (guides) so that to expose unwanted hair according to individual's needs. Please see Diagram 1.

What I claim is:

1. A back-hair-trim-guide with an adjustable mirror for man self trims his back and side hair safely and effectively with a clipper. It comprises the following parts:
1. A bar with three layers:
The first layer of this bar is for engaging the head of the person whose back and side hair is to be trimmed.
The second layer of this bar will hold two movable guides to protect and cover the back and side hair, and expose the unwanted hair to be trimmed.
The third layer of this bar will hold a mirror which is going to slide along the bar from one end to the other so that the person can have a vision of his back and side hair to be trimmed by looking at the front mirror into this attached mirror.
2. The movable trim guides.
There are two identical guides both having the shape of back and side hair. They are attached to the second layer of the said bar, and movable along the said bar so that a person can adjust the covered hair.
3. The movable and adjustable mirror.
This mirror is attached to the third layer of the said bar through its handle, and can move along the said bar to adjust its angle so that the person can see his back and side hair by looking at the front mirror into this mirror when trimming the unwanted hair. This mirror has a handle which it self is flexible and adjustable to reflect the back and side hair position.
